(19) United States
(12) Patent Application Publication
(10) Pub. No.: US 2007/0014208 A1
(43) Pub. Date: Jan. 18, 2007

(54) Data recording/reproducing method in recording media

(75) Inventor: Sahngjoon Auh, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/483,591

(22) Filed: Jul. 11, 2006

(30) Foreign Application Priority Data
Jul. 12, 2005 (KR) 10-2005-0062984

(51) Int. Cl. G11B 7/00

(52) U.S. Cl. 369/44.28

(57) ABSTRACT

A data recording/reproducing method in recording media is disclosed in which track pitches and sector lengths are differently formed, wherein the method comprises: discriminating whether a target position and a current position of an optical pick-up are present in a zone where track pitches are different thereamong in response to data recording/reproducing command; and moving the optical pick-up to the target position via a boundary position where the track pitches are changed if it is discriminated that the current position and the target position of the optical pick-up are present in the zone where the track pitches are different thereamong, such that the optical pick-up can be accurately and swiftly moved to the target position during a data recording/reproducing operation in a high density optical disc where track pitches and sector lengths are not uniform.

This application claims priority under 35 U.S.C. §119 to Korean Application No. 10-2005-0062984 filed on Jul. 12, 2005, which is hereby incorporated by reference.

### BACKGROUND

This description relates to a data recording/reproducing method in recording media in which a track pitch and a sector length are differently formed.

In recent years, different types of disc-shaped recording and storing media of digital audio and video data including, for example, a compact disc (CD) and a digital versatile disc (DVD) have been developed and widely commercialized. Specifically, great efforts have been given at full speed to the standardization of a high density optical disc for storing a large capacity of high definition video data and high fidelity audio data, for example, Blu-ray Disc (BD).

The BD is a type of optical disk specification that allows for high storage capacity. The high storage capacity is realized by causing a laser beam to have a short wavelength, and increasing a numerical aperture (NA) of an objective lens. Specifically, the high storage capacity is realized by using an objective lens having a NA of 0.85 and a laser beam having a wavelength of 405 nm.

In other words, the BD discs are optical recording media onto which a large amount of data can be recorded. The BD discs have a track pitch which is about half of that of existing CDs or DVDs, or about 0.32 μm. As a result, it is possible to record or reproduce a maximum of 27 GB data onto or from one side of a 120 mm blue-ray disc. In order to increase the capacity, blue-ray discs employ a disc structure having a 405 nm bluish-purple semiconductor laser, a much shorter and denser than that of the DVD playable with a red laser beam having a wavelength of about 650 nm, an object lens having a numerical aperture (NA) of 0.85, and a light-permeable protective layer having a thickness of 0.1 mm.

The BD therefore can record or reproduce data corresponding to moving images of 12 hours equivalent to a picture quality of a standard grade TV (SDTV) and moving images of 2 hours equivalent to a picture quality of a high definition TV.

Meanwhile, in case of a high density optical disc such as a BD or a HD-DVD, a track pitch of information recording area in which disc information is stored, a track pitch of data recording area in which data is recorded and a sector length are differently formed.

For example, as illustrated in FIG.1, the HD-DVD type disc (ROM/R/RE) is divided into a system lead-in area, a connection area, a data lead-in area and a data area. The track pitch of the system lead-in area is 0.68 μm, and all the track pitches subsequent to the connection area are formed of 0.34 μm.

Meanwhile, as illustrated in FIG. 2, BD type disc (ROM/R/RE) comprises: information area divided into an inner area, a clamping area, a transition area, a lead-in zone, a data zone and a lead-out zone; and a rim area. Furthermore, the lead-in area is divided into a first guard (protection 1) area, permanent information and control (PIC) data area, a second guard (protection 2) area, and an information 2 area. A track pitch of the PIC area is formed of 0.35 μm, based on the second guard (protection 2) area allocated to the lead-in zone in the BD type disc, and all the track pitches subsequent to the second guard (protection 2) area are of 0.32 μm.

The track pitch is one of the important operating factors for determining a movement of an optical pick-up when the optical pick-up is to be moved to a desired target position from a current position in response to data reproduction command.

As noted above, however, track pitches of an area in which disc information is stored and an area in which data is stored, and a sector length are differently positioned, relative to those of the conventional CD or DVD. As a result, track pitches differently positioned relative to a current position and a target position of an optical pick-up and a sector length should be reflected adaptively in determining the movement of the optical pick-up so that the optical pick-up can be accurately moved to a desired target position.

If movement of an optical pick-up is not accurately calculated, there occurs a problem of the optical pick-up reaching a position deviated from a target position. In this case, the movement of the optical pick-up should be re-calculated by comparing the current position with the target position of the optical pick-up in order to move again the optical pick-up to the target position. There occurs another problem of consuming lots of time for performing an operation of moving the optical pick-up to the desired target position.

### SUMMARY

The present invention is disclosed to provide a data recording/reproducing method in recording media by which an optical pick-up can be rapidly and precisely moved to a desired target position in a recording medium in which track pitches and section lengths are differently positioned.

In accordance with the object of the present invention, there is provided a data recording/reproducing method in recording media, the method comprising: discriminating whether a target position and a current position of an optical pick-up are present in a zone where track pitches are different thereamong in response to a data recording/reproduction command; and moving the optical pick-up to the target position via a boundary position where the track pitches are changed if it is discriminated that the current position and the target position of the optical pick-up are present in the zone where the track pitches are different thereamong.

The discriminating step is to determine whether the current position and the target position of the optical pick-up are present in the zone where the track pitches are different thereamong by comparing address values corresponding to the current position and the target position of the optical pick-up with an address value corresponding to the boundary position.

It is determined in the discriminating step that the current position and the target position of the optical pick-up are present in the zone where the track pitches are different thereamong, if the address value corresponding to the target position is smaller than the address value corresponding to the boundary position, and the address value corresponding to the current position of the optical pick-up is equal to or greater than the address value corresponding to the boundary position.

It is further determined in the discriminating step that the current position and the target position of the optical pick-up are present in a zone where the track pitches are different thereamong, if the address value corresponding to the target position of the optical pick-up is greater than the address value corresponding to the boundary position, and the address value corresponding to the current position of the optical pick-up is smaller than or equal to the address value corresponding to the boundary position.

The step of moving the optical pick-up is such that the optical pick-up is moved to the target position via a boundary position closest to the target position, if a plurality of boundary positions where the track pitches are changed are present between the current position of the optical pick-up and the target position.

In the step of moving the optical pick-up, the optical pick-up is moved to the target position via a first boundary address position, if the address value corresponding to the target position of the optical pick-up is smaller than a first boundary address value showing a start of the boundary position, and the address value corresponding to the current position of the optical pick-up is equal to or greater than a second boundary address value showing an end of the boundary position.

The movement of the optical pick-up to the target position via the first boundary address position comprises: comparing the current address value of the optical pick-up with the first boundary address value to determine an amount of movement of the optical pick-up, and to move the optical pick-up as much as the determined amount of movement; and comparing the first boundary address value with an address value corresponding to the target position of the optical pick-up to determine the amount of the movement of the optical pick-up and to move the optical pick-up as much as the determined amount of movement, if the optical pick-up reaches the first boundary address position.

The amount of movement of the optical pick-up for moving the optical pick-up from the current address position to the boundary address position comprises: calculating track numbers corresponding to the current address value of the optical pick-up and the first boundary address value; calculating a difference between the track number corresponding to the calculated current address value and the calculated first boundary address value to calculate a moving direction of the optical pick-up and the number of tracks; and multiplying the calculated number of tracks by a track pitch value of a track corresponding to the current address value to calculate a moving distance to be covered by the optical pick-up, and to determine an amount of movement of the optical pick-up based on the calculated moving distance.

The calculation of the number of tracks between the track number corresponding to the current address value and the track number corresponding to the first boundary address value comprises: calculating a difference between the track number corresponding to the current address value and the track number corresponding to the second boundary address value to calculate the number of tracks to be covered by the optical pick-up; and adding the calculated number of tracks to the number of tracks between pre-calculated and stored first and second boundary addresses to calculate the number of tracks between the current address value and the first boundary address value.

Furthermore, the amount of movement of the optical pick-up for moving the optical pick-up from the first boundary address position to the target position comprises: calculating a track number corresponding to the target address value of the optical pick-up; calculating a difference between the track number corresponding to the first boundary address value and the track number corresponding to the target address value to calculate the moving direction of the optical pick-up and the number of tracks; and multiplying the calculated number of tracks by the track pitch value of the track corresponding to the target address value to calculate the moving distance of the optical pick-up, and to determine the amount of movement of the optical pick-up based on the calculated moving distance.

Meanwhile, the step of moving the optical pick-up comprises: moving the optical pick-up is moved to the target position via the second boundary address, if the address value corresponding to the target position of the optical pick-up is greater than a second boundary address value showing the end of the boundary position, and the address value corresponding to the current position of the optical pick-up is smaller than or equal to a first boundary address value showing the start of the boundary position.

Movement of movement of the optical pick-up to the target position via the second boundary address position comprises: comparing the current address value of the optical pick-up with the second boundary address value to determine the amount of movement of the optical pick-up and to move the optical pick-up as much as the determined amount of movement; and comparing the second boundary address value with the target address value of the optical pick-up to determine the amount of movement of the optical pick-up and to move the optical pick-up as much as the determined amount of movement, if the optical pick-up reaches the second boundary address position.

The amount of movement of optical pick-up for moving the optical pick-up from the current address position to the second boundary address position comprises: calculating track numbers corresponding to the current address value and the second boundary address value; calculating a difference between the calculated track number corresponding to the current address value and the track number corresponding to the second boundary address value to calculate the moving direction of the optical pick-up and the number of tracks; and multiplying the calculated number of tracks by a track pitch value corresponding to the current address value to calculate the moving distance to be covered by the optical pick-up, and to determine the amount of movement of the optical pick-up based on the calculated moving distance.

The calculation of the number of tracks between the track number corresponding to the current address value and the track number corresponding to the second boundary address value comprises: calculating a difference between the track number corresponding to the current address value and the track number corresponding to the first boundary address value to calculate the number of tracks to be covered by the optical pick-up; and adding up the calculated number of tracks to the number of tracks between the first boundary address value and the second boundary address value to calculate a total number of tracks between the current address value and the second boundary address value.

Furthermore, the amount of movement of the optical pick-up for moving from the second boundary address position to the target address position comprises: calculating a track number corresponding to the target address value; calculating a difference between the track number corresponding to the second boundary address value and the track number corresponding to the target address value to calculate the moving direction of the optical pick-up and the number of tracks; and multiplying the calculated number of tracks by a track pitch value corresponding to the target address value to calculate the moving distance of the optical pick-up, and to determine the amount of movement of the optical pick-up based on the calculated moving distance.

Furthermore, a data recording/reproducing method in recording media comprises: discriminating whether a target position and a current position of an optical pick-up are present in a zone where track pitches are different thereamong in response to a data recording/reproducing command; and using a boundary address value in which track pitches are changed and track pitch values of each zone to determine an amount of movement for moving the optical pick-up to a target position if the current position and the target position of the optical pick-up are respectively present in a zone where the track pitches are different thereamong as a result of the discrimination; and moving the optical pick-up as much as the determined amount of movement.

The discriminating step is to determine whether the current position and the target position of the optical pick-up are present in the zone where the track pitches are different thereamong by comparing address values corresponding to the current position and the target position of the optical pick-up with the boundary address value.

The boundary address value is an address value closest to an address value corresponding to the target position of the optical pick-up, if a plurality of boundary address values is present between the current position of the optical pick-up and the target position.

The step of determining the amount of movement when the optical pick-up is moved from a first zone to a second zone where track pitches are different comprises: calculating track numbers corresponding to an address value corresponding to the current position of the optical pick-up, an address value corresponding to the target position, a first boundary address value showing a start of the boundary address value, and a second boundary address value showing an end of the boundary address value; calculating a first number of tracks between a track number corresponding to the current address value of the optical pick-up and a track number corresponding to the first boundary address value and a second number of tracks between a track number corresponding to the second boundary address value and a track number corresponding to the target address value; multiplying the first number of tracks by a track pitch value of a track corresponding to the current address value to calculate a first moving distance to be covered by the optical pickp-up, and multiplying the second number of tracks by a track pitch value of a track corresponding to the target address value to calculate a second moving distance; adding up the calculated first moving distance to the second moving distance and a moving distance between the pre-calculated and stored first and second boundary address values to calculate a total moving distance to be covered by the optical pick-up, and determining an amount of movement of the optical pick-up based on the calculated total moving distance.

Meanwhile, the step of determining the amount of movement of the optical pick-up from the second zone to the first zone where the track pitches are different comprises: calculating track numbers corresponding to an address value corresponding to the current position of the optical pick-up, an address value corresponding to the target position, a first boundary address value showing a start of the boundary address value, and a second boundary address value showing an end of the boundary address value; calculating a first number of tracks between a track number corresponding to the current address value of the optical pick-up and a track number corresponding to the second boundary address value and a second number of tracks between a track number corresponding to the first boundary address value and a track number corresponding to the target address value; multiplying the first track number by a track pitch value of a track corresponding to the current address value to calculate a first moving distance to be covered by the optical pick-up and multiplying the second track number by a track pitch value of a track corresponding to the target address value to calculate a second moving distance; and adding the calculated first moving distance to the second moving distance and a moving distance between the pre-calculated and stored first and second boundary address values to calculate a total moving distance to be covered by the optical pick-up and to determine the amount of movement of the optical pick-up based on the calculated total moving distance.

### BRIEF DESCRIPTION OF THE DRAWINGS

FIG. 1 illustrates a disc structure relative to HD-DVD type disc.

FIG.2 illustrates a disc structure relative to BD type disc.

FIG. 3 is a schematic block diagram illustrating a high density optical disc apparatus according to a preferred embodiment of the present invention.

FIG. 4 illustrates a process for discriminating whether a current position and a target position of an optical pick-up are present in an area where track pitches are different.

FIG. 5 is a flowchart illustrating a data recording/reproducing method in recording media according to a first embodiment of the present invention.

FIG. 6 is a flowchart illustrating a data recording/reproducing method in recording media according to a second embodiment of the present invention.

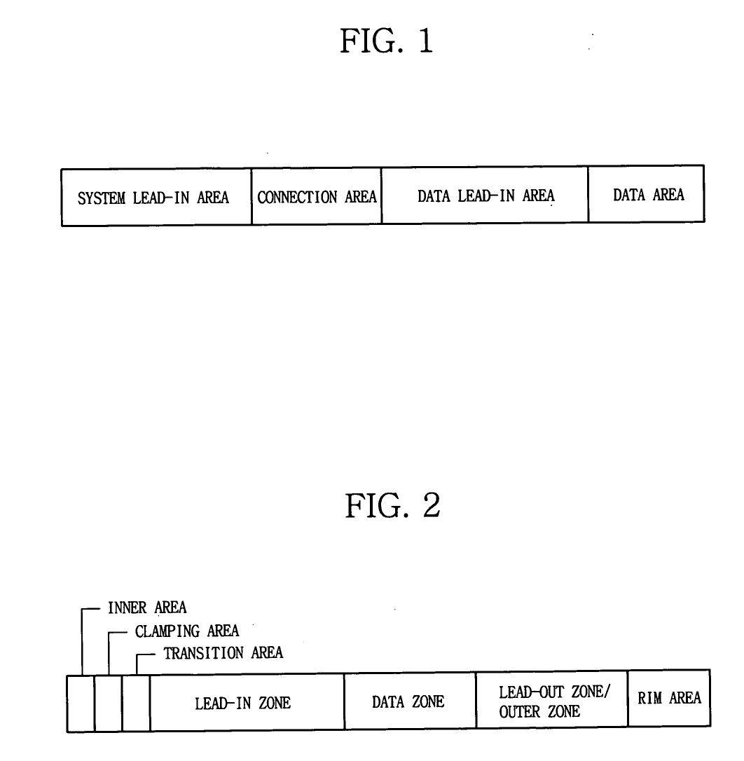

### DETAILED DESCRIPTION

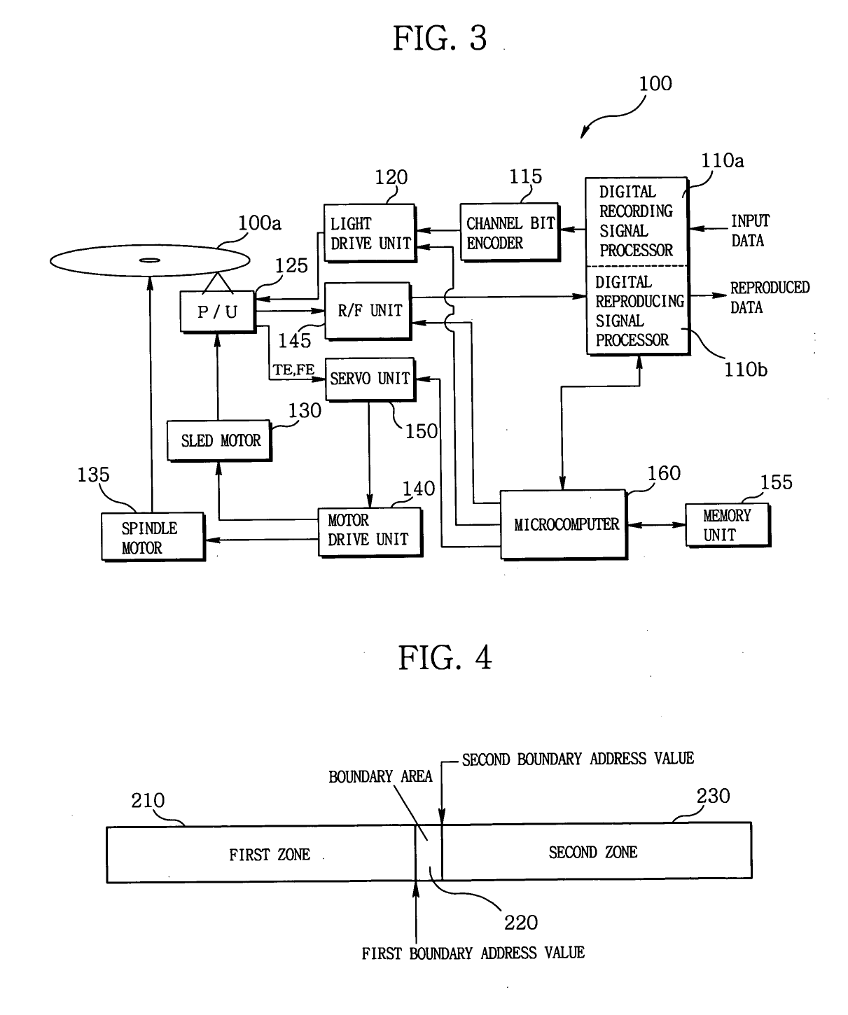

Referring to FIG. 3, a high density optical disc apparatus 100 according to the present invention comprises: a digital recording signal processor 110a for adding an error correction code (ECC) or the like to input digital data to convert it to a recording format; a channel bit encoder 115 for reconverting the recording formatted data to a bit stream; a light drive unit 120 for outputting a light drive signal in correspondence to an input signal from the channel bit encoder 115; an optical pick-up 125 for recording data according to the light drive signal on a high density optical disc (100a. hereinafter referred to as “an optical disc”), or for using light reflected from the optical disc 100a to read a recording signal; a sled motor 130 for moving the optical pick-up 125 to a radial direction of the optical disc 100a; a spindle motor 135 for rotating the optical disc 100a; a motor drive unit 140 for driving the sled motor 130 and the spindle motor 135; an R/F unit 145 for performing filtering and waveform shaping on a signal detected by the optical pick-up 125 and outputting a resulting binary signal; a servo unit 150 for receiving a focus error (FE) signal and a tracking error (TE) signal outputted from the optical pick-up 125 to control the operation of the motor drive unit 140; a digital reproducing signal processor 110b for restoring the binary signal outputted from the R/F unit 145 into original digital data; a memory unit 155 for storing information on a boundary area where track pitches and sector lengths used for implementing a data recording/reproducing operation are changed in response to data recording/reproducing command; and a microcomputer 160 for controlling operation of moving the optical pick-up 125 to a selected target position, and data recording/reproducing operation.

The high density optical disc apparatus 100 is an optical recording/reproducing apparatus capable of recording data inputted to the optical disc 100a, or reading data recorded on the optical disc 100a and reproducing it. An example of the optical disc applied to the present invention includes a HD-DVD type optical disc (i.e., HD-DVD-ROM/R/RE), a BD type optical disc (i.e., BD-ROM/R/RE) or the like.

The high density optical disc apparatus 100 discriminates whether a current position and a target position of the optical pick-up 125 are present in zones where track pitches and sector lengths are different when the optical pick-up 125 is to be moved from a currently-positioned track to a desired target position in response to the data recording or reproducing command. For this, the microcomputer 160 compares the current address value and the target address value of the optical pick-up 125 with the first and second boundary address values stored in the memory unit 155 to discriminate whether the current position and the target position of the optical pick-up 125 are present in the zones where track pitches are different or multiform.

Now, referring to FIG. 4, a first zone 210 and a second zone 230, divided on the basis of a boundary area 220 in which track pitches and sector lengths are changed, are zones where the track pitches and the sector lengths are differently formed. At this time, if a currently-loaded optical disc 100a is a BD type disc, the first zone 210 is a PIC zone in which principal disc information is recorded, the boundary area 220 is a protection zone 2, and the second zone 230 covers all the zones subsequent to the protection zone 2. A track pitch of the first zone 210 is 0.35 μm, a track pitch of the second zone 230 is 0.32 μm, and the boundary area 220 is a section where a track pitch is changed from 0.35 μm to 0.32 μm.

Alternatively, if the currently-loaded optical disc 100a is a HD-DVD type disc, the first zone 210 is a system lead-in area, the boundary area 220 is a connection area, and the second zone 230 covers a data lead-in area and a data area. Furthermore, a track pitch of the first zone 210 is 0.64 μm, a track pitch of the second zone 230 is 0.34 μm, and the boundary area 220 is a section where a track pitch is changed from 0.64 μm to 0.34 μm.

Meanwhile, the current address value of the optical pick-up 125 corresponds to a sector number, and can be known by a digital data which is reproduction control information where a signal detected by the optical pick-up 125 is signal-processed and inputted by the R/F unit 145 and the digital reproducing signal processor 10b. The first and second boundary address values, which are bases for discriminating whether the current position and the target position of the optical pick-up 125 are present in an area where track pitches are different, are determined by a disc standard, and differ according to the kind of disc. For example, in case of a HD-DVD type disc, the first boundary address value is “O×026AFFh”, which is equally applied to a HD-DVD-ROM/R/RE medium, but the second boundary address value differs according to the kind of the disc. For example, the second boundary address value for a reproduction-only HD-DVD-ROM medium and a write-once HD-DVD−R medium is “O×026Booh”, but the second boundary address value of rewritable HD-DVD-RE medium is “O×029Aooh”.

On the other hand, the first boundary address value of a BD type disc is “O×ODA3FEh”, which is equally applied to a BD-ROM/R/RE medium, but the second boundary address value differs according to the kind of the disc. For example, the second boundary address value of a reproduction-only HD-DVD-ROM medium is “O×oDCoooh”, while the second boundary address value for a write-once HD-DVD−R medium and a rewritable HD-DVD-RE medium is “O×O1B800h”. The first and second boundary address values are stored in the memory unit 155.

Now, a brief description is given as below based on the aforementioned content, for a process discriminating whether the current position and the target position of the optical pick-up 125 are present in an area where track pitches are different or multiform.

The microcomputer 160 compares the current address value and the target address value of the optical pick-up 125 with the first and second boundary address values to determine that the current position and the target position of the optical pick-up 125 are present in an area where the track pitches are different if the target address value is smaller than the first and second boundary address values, and the current address value is equal to or greater than the second boundary address value. In this case, the situation is that the current optical pick-up 125 is positioned on an arbitrary track out of tracks within the second zone 230, but an arbitrary position within the first zone 210 has been selected as a target position.

Furthermore, the microcomputer 160 also determines, as a result of the comparison, that the current position and the target position of the optical pick-up 125 are present in an area where the track pitches are different if the selected target address value is greater than the second boundary address values, and the current address value is equal to or smaller than the first boundary address value. In this case, the situation is that the current optical pick-up 125 is positioned on an arbitrary track out of tracks within the first zone 210, but an arbitrary position within the second zone 230 has been selected as a target position.

As noted above, if it is determined that the current position and the target position of the optical pick-up 125 are present in a zone where track pitches are differently formed, the movement of the optical pick-up 125 is determined in consideration of track pitch value of each zone and sector length. Furthermore, the optical pick-up 125 is moved to the target position via a position corresponding to the first boundary address value or a position corresponding to the second boundary address value, or the optical pick-up 125 is moved direct to the target position, not via positions corresponding to the first or second boundary address value when the optical pick-up 125 is moved from the current position to the target position.

Meanwhile, the optical pick-up 125 is moved to a target position via a boundary position closest to the target position when the optical pick-up 125 is moved to the target position via a boundary position where track pitches are changed, if there are present a plurality of boundary positions between the current position of the optical pick-up 125 and the target position.

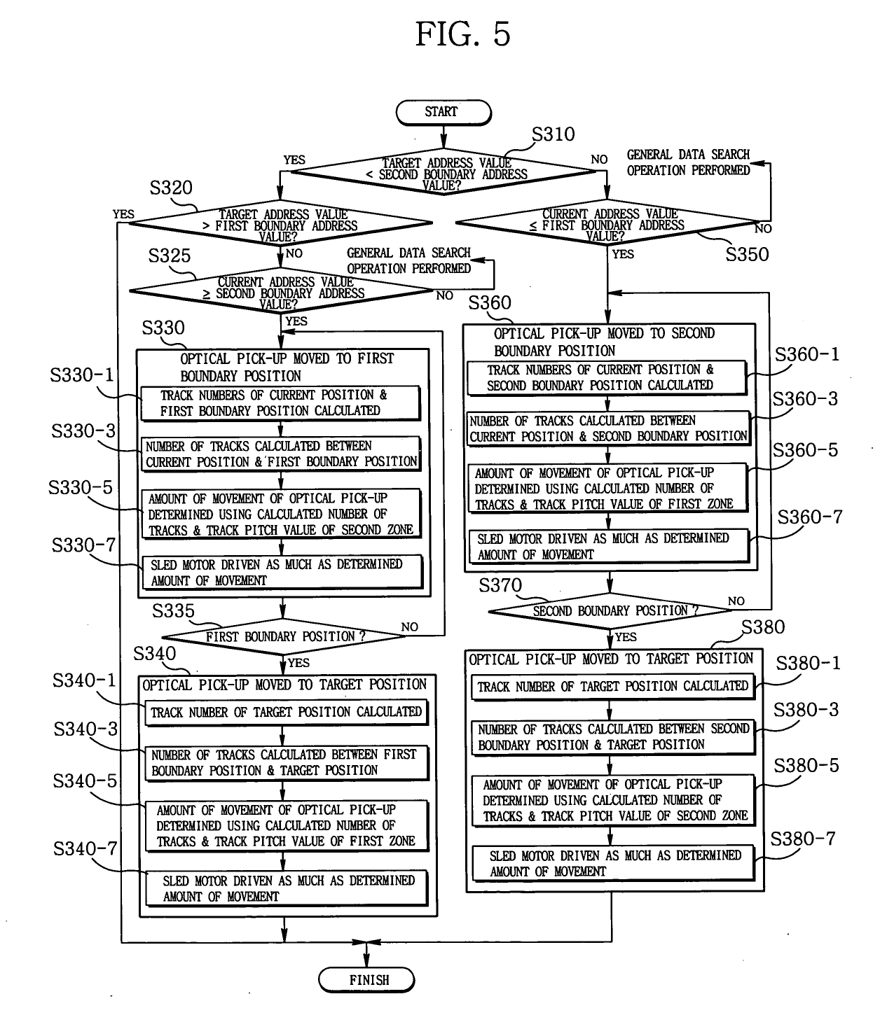

Now, referring to FIG. 5, the microcomputer 160 compares the target address value of the optical pick-up 125 selected in response to a data recording/reproducing command with the second boundary address value stored in the memory unit 155 (S310).

If it is determined as a result of the comparison that the target address value of the optical pick-up 125 is smaller than the second boundary address value, the microcomputer determines that the target address value is greater than the first boundary address value (S320). As a result of the determination at S320, if it is determined that the target address value is greater than the first boundary address value, the microcomputer 160 determines that the target address value of the optical pick-up 125 is present between a position corresponding to the first boundary address value and a position corresponding to the second boundary address value to terminate the data recording/reproducing operation.

Meanwhile, if it is determined at S320 that the target address value is smaller than the first boundary address value, the microcomputer 160 compares the current address value of the optical pick-up 125 with the second boundary address value in order to determine a zone where the optical pick-up 125 is presently situated (S325).

As a result of the comparison, if it is determined that the current address value of the optical pick-up 125 is equal to or greater than the second boundary value, the microcomputer 160 compares the current address value of the optical pick-up 125 with the first boundary address value to determine the amount of movement of the optical pick-up 125, and moves the optical pick-up 125 to a position corresponding to the first boundary address value (hereinafter referred to as “a first boundary position”) (S330). In this case, the situation is that the current optical pick-up 125 is positioned on an arbitrary track out of the tracks within the second zone 230, and the arbitrary position of the first zone 210 is selected the target position, such that the optical pick-up 125 is intended to be moved from the second zone 230 to the first zone 210.

Now, the step of S330 will be described in more detail.

First of all, the microcomputer 160 uses the current address value of the optical pick-up 125 and the first boundary address value stored in the memory unit 155 to calculate track numbers corresponding to the current position and the first boundary position (S330-1). The track numbers of each position can be calculated by relevant address values, i.e., sector numbers, sector lengths and track pitch values.

The microcomputer 160 calculates a difference between the calculated track number corresponding to the current position and a track number corresponding to the first boundary position to calculate the moving direction of the optical pick-up 125 and the number of tracks (S330-3). The calculation of the number of tracks between the current position and the first boundary position is performed in such a manner that a difference between the track number corresponding to the current position and a track number corresponding to a position corresponding to the second boundary address value (hereinafter referred to as “a second boundary position”) is extracted to calculate the number of tracks to be covered by the optical pick-up 125, and the calculated number of tracks is added to the number of tracks between the pre-calculated and stored first and second boundary address values to calculate the number of tracks between the current position and the first boundary position. The number of tracks between the first and second boundary address values may be simply obtained by using a physical distance between the first and second boundary addresses and track pitch values corresponding thereto. The values are calculated in advance and stored in the memory unit 155.

Furthermore, the microcomputer 160 multiplies the calculated number of tracks by a track pitch value of a track where the optical pick-up 125 is currently positioned, i.e., a track pitch value corresponding to the second zone 230 to calculate the moving distance to be covered by the optical pick-up 125, and uses the calculated moving distance to determine an amount of movement to be covered by the optical pick-up 125 (S330-5). The amount of movement of the optical pick-up 125 based on the moving distance is constructed in the form of a look-up table and stored in the memory unit 155. The amount of the movement of the optical pick-up 125 is determined by selection and output of the amount of movement corresponding to the moving distance calculated from the look-up table stored in the memory unit 155. The microcomputer 160 controls the servo unit 150 so as to drive the sled motor to as much as the determined amount of movement (S330-7).

Followed by the movement of the optical pick-up 125 as much as the determined amount of movement, the microcomputer 160 reads current position information of the optical pick-up 125 based on a signal outputted from the digital reproducing signal processor 10b to discriminate whether the optical pick-up 125 has moved to the first boundary position (S335).

As a result of the discrimination, if it is determined that the optical pick-up 125 has reached the first boundary position, the microcomputer 160 compares the current address value of the optical pick-up 125, i.e., the first boundary address value with the target address value to determine the amount of the movement of the optical pick-up 125 and to move the optical pick-up 125 to the target position (S340).

The step of S340 will be described in more detail as below.

The microcomputer 160 uses the target address value of the optical pick-up 125 to calculate a track number corresponding to the target position (S340-1), and calculates a difference between the track number corresponding to the first boundary position calculated at Step 340-1 and the track number of the target position to calculate the number of tracks between the first boundary position and the target position (S340-2).

The microcomputer 160 multiplies the calculated number of tracks by a track pitch value corresponding to the target position, i.e., the track pitch value corresponding to the first zone 210 to calculate a moving distance to be covered by the optical pick-up 125, and to determine the amount of movement using the calculated moving distance (S340-5). Successively, the microcomputer 160 controls the servo unit 150 to drive the sled motor 130 as much as the determined amount of movement (S340-7).

Meanwhile, if it is determined as a result of comparison at Step 310 that the target address value of the optical pick-up 125 is greater than the second boundary address value, the microcomputer 160 discriminate whether the current address value of the optical pick-up 125 is less than the first boundary address value (S350).

As a result of the comparison, if it is determined that the current address value of the optical pick-up 125 is equal to or smaller than the first boundary address value, the microcomputer 160 moves the optical pick-up 125 to a position corresponding to the second boundary address value (hereinafter referred to as “a second boundary position”) (S360). In this case, the situation is such that the current optical pick-up 125 is positioned on an arbitrary track out of tracks within the first zone 210, but an arbitrary position within the second zone 230 has been selected as a target position and the optical pick-up 125 is intended to be moved from the first zone 210 to the second zone 230.

Now, the Step 360 will be described in more detail as below.

The microcomputer 160 uses the current address value and the second boundary address value of the optical pick-up 125 to calculate track numbers corresponding to the current position and the second boundary position (S360-1). The microcomputer 160 calculates a difference between the calculated track number corresponding to the current position and the track number corresponding to the second boundary position to calculate a moving direction of the optical pick-up 125 and the number of tracks (S360-3). The calculation of the number of tracks between the current position and the second boundary position is performed in such a manner that a difference between the track number corresponding to the current position and a track number corresponding to a position corresponding to the first boundary address value is extracted to calculate the number of tracks to be covered by the optical pick-up 125, and the calculated number of tracks is added to the number of tracks between the pre-calculated and stored first and second boundary address values to calculate the number of tracks between the current position and the second boundary position.

Successively, the microcomputer 160 multiplies the calculated number of tracks by a track pitch value corresponding to a track on which the optical pick-up 125 is positioned, i.e., the track pitch value corresponding to the first zone 210 to calculate a moving distance to be covered by the optical pick-up 125, and to determine the amount of movement using the calculated moving distance (S360-5). Subsequently, the microcomputer 160 controls the servo unit 150 to drive the sled motor 130 as much as the determined amount of movement (S360-7).

Followed by the movement of the optical pick-up 125 as much as the determined amount of movement, the microcomputer 160 reads current position information of the optical pick-up 125 based on a signal outputted from the digital reproducing signal processor 110b to discriminate whether the optical pick-up 125 has moved to the second boundary position (S370).

As a result of the discrimination, if it is determined that the optical pick-up 125 has reached the second boundary position, the microcomputer 160 compares the current address value of the optical pick-up 125, i.e., the second boundary address value with the target address value to determine the amount of the movement of the optical pick-up 125 and to move the optical pick-up 125 to the target position (S380).

Now, the step of S380 will be described in more detail as below.

First of all, the microcomputer 160 uses the target address value of the optical pick-up 125 to calculate a track number corresponding to the target position (S380-1), and calculates a difference between the track number corresponding to the second boundary position calculated at Step 360-1 and the track number of the target position to calculate the number of tracks between the second boundary position and the target position (S380-3).

The microcomputer 160 multiplies the calculated number of tracks by a track pitch value corresponding to the target position to calculate a moving distance to be covered by the optical pick-up 125, and to determine the amount of movement using the calculated moving distance (S380-5). Successively, the microcomputer 160 controls the servo unit 150 to drive the sled motor 130 as much as the determined amount of movement (S380-7).

Meanwhile, if it is determined as a result of comparison at Step 325 that the current address value of the optical pick-up 125 is smaller than the second boundary address value, or if it is determined as a result of comparison at Step 350 that the current address value of the optical pick-up 125 is greater than the first boundary address value, the microcomputer 160 performs the data recording/reproducing operation according to the conventional determining method of amount of the movement because this is the case where current and target positions of the optical pick-up 125 are present in a zone where track pitches are uniform.

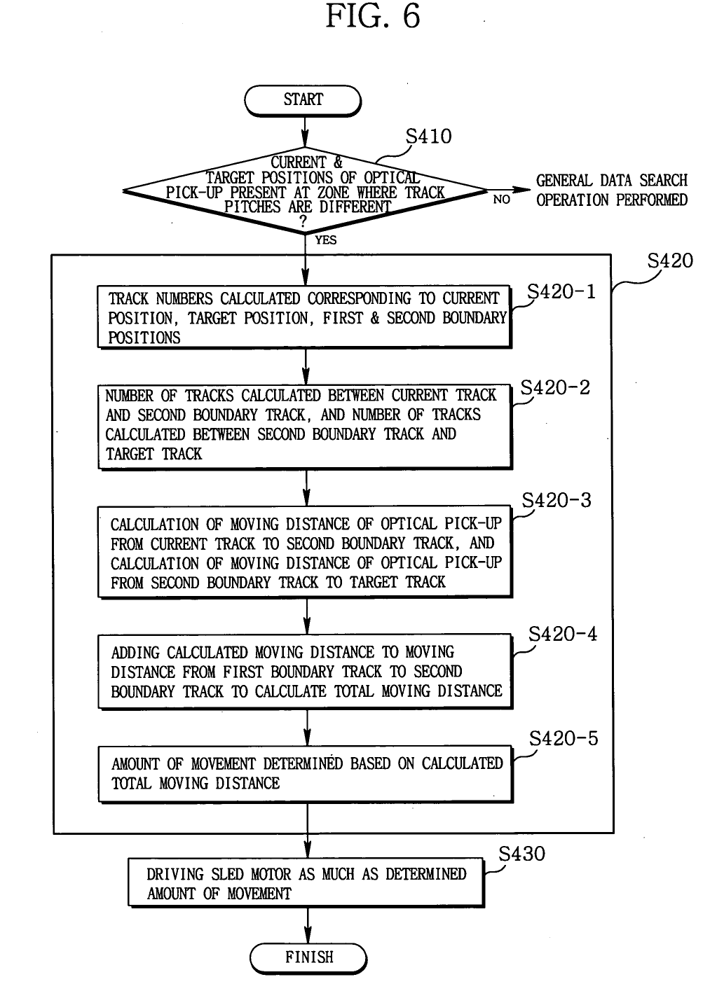

Now, referring to FIG. 6, a method according to a second embodiment of the present invention is described where the optical pick-up 125 is moved direct to the target position without going through the pre-set first or second boundary address values when the optical pick-up 125 is to be moved from the current position to the target position. By this method, the optical pick-up speed can be further improved over the data recording/reproducing method of the first embodiment.

Hereinafter, a method for moving the optical pick-up 125 located in the first zone 210 to the second zone 230 will be described with examples.

Referring again to FIG. 6, the microcomputer 160 compares the current address value and the target address value with the first and second boundary address values stored in the memory unit 155 in response to receipt of data recording/reproducing command to discriminate whether the current position and the target position of the optical pick-up 125 are present in a zone where track pitches are not uniform (S410).

As a result of the discrimination at Step 410, if the current position and the target position of the optical pick-up 125 are present in a zone where the track pitches are different, the microcomputer 160 employs the first and second boundary addresses and track pitch value of each zone to determine an amount of movement for moving the optical pick-up 125 to the target position (S420).

Now, the process of determining the amount of movement at Step 420 will be described in more detail as under.

First of all, the microcomputer 160 calculates track numbers corresponding to the current address value, the target address value, the first boundary address value and the second boundary address value of the optical pick-up 125 (S420-1). The microcomputer 160 calculates the number of tracks (first track value) between a track corresponding to the current address value (current track) and a track (second boundary track) corresponding to the second boundary address value, and the number of tracks (second track value) between the second boundary track and a track (target track) corresponding to the target address value (S420-2).

Successively, the first track value is multiplied by a track pitch value of a track corresponding to the current address value, i.e., a track pitch value corresponding to the first zone 210 to calculate a moving distance (first moving distance) to be covered by the optical pick-up 125 from the current track to the second boundary track, and multiplies the second track value by a track pitch value of a track corresponding to the target address value, i.e., a track pitch value corresponding to the second zone 230 to calculate a moving distance (second moving distance) to be covered by the optical pick-up 125 from the second boundary track to the target track (S420-3). Subsequently, the calculated first moving distance is added by the second moving distance and a moving distance (third moving distance) between the pre-calculated and stored first boundary track and the second boundary track to calculate a total moving distance to be covered by the optical pick-up 125 (S420-4).

The amount of movement of the optical pick-up 125 is determined based on the calculated total moving distance (S420-5). At this time, it should be apparent that the total amount of movement of the optical pick-up 125 can be determined by adding up an amount of movement corresponding to the calculated first moving distance, an amount of movement corresponding to the calculated second moving distance and an amount of movement corresponding to the calculated third moving distance.

Lastly, the microcomputer 160 controls the servo unit 150 so as to drive the sled motor as much as the amount of movement determined at Step 420.

Meanwhile, if it is determined as a result of the discrimination at Step 410 that the current position and the target position of the optical pick-up 125 are present in a zone where the track pitches are uniform, the microcomputer 160 performs the data recording/reproducing operation according to the conventional determination method of the amount of movement.

As apparent from the foregoing, there is an advantage in that an optical pick-up can be accurately and swiftly moved to a target position during the data recording/reproducing operation in recording media where track pitches and sector lengths are not uniform.

What has been described above includes examples of the present invention. It is, of course, not possible to describe every conceivable combination of components or methodologies for purposes of describing the present invention, but one of ordinary skill in the art can recognize that many further combinations and permutations of the present invention are possible. Accordingly, the present invention is intended to embrace all such alterations, modifications and variations that fall within the spirit and scope of the appended claims. Furthermore, to the extent that the term “includes” is ever used in either the detailed description or the claims, such term is intended to be inclusive in a manner similar to the term “comprising” as “comprising” is interpreted when employed as a transitional word in a claim.

What is claimed is:

1. A data recording/reproducing method in recording media, the method comprising: discriminating whether a target position and a current position of an optical pick-up are present in a zone where track pitches are different thereamong in response to a data recording/reproducing command; and moving the optical pick-up to the target position via a boundary position where the track pitches are changed if it is discriminated that the current position and the target position of the optical pick-up are present in the zone where the track pitches are different thereamong.

2. The method as defined in claim 1, wherein the discriminating step discriminates whether the current position and the target position of the optical pick-up are present in the zone where the track pitches are different thereamong by comparing address values corresponding to the current position and the target position of the optical pick-up with an address value corresponding to the boundary position.

3. The method as defined in claim 2, wherein the discriminating step determines that the current position and the target position of the optical pick-up are present in the zone where the track pitches are different thereamong, if the address value corresponding to the target position is smaller than the address value corresponding to the boundary position, and the address value corresponding to the current position of the optical pick-up is equal to or greater than the address value corresponding to the boundary position.

4. The method as defined in claim 2, wherein the discriminating step determines that the current position and the target position of the optical pick-up are present in a zone where the track pitches are different thereamong, if the address value corresponding to the target position of the optical pick-up is greater than the address value corresponding to the boundary position, and the address value corresponding to the current position of the optical pick-up is smaller than or equal to the address value corresponding to the boundary position.

5. The method as defined in claim 1, wherein the step of moving the optical pick-up is such that the optical pick-up is moved to a target position via a boundary position closest to the target position, if there are present a plurality of boundary positions where the track pitches are changed between the current position of the optical pick-up and the target position.

6. The method as defined in claim 1, wherein the step of moving the optical pick-up is such that the optical pick-up is moved to the target position via a first boundary address position, if the address value corresponding to the target position of the optical pick-up is smaller than a first boundary address value showing a start of the boundary position, and the address value corresponding to the current position of the optical pick-up is equal to or greater than a second boundary address value showing an end of the boundary position.

7. The method as defined in claim 1, wherein the step of moving the optical pick-up is such that the optical pick-up is moved to the target position via the second boundary address, if the address value corresponding to the target position of the optical pick-up is greater than a second boundary address value showing the end of the boundary position, and the address value corresponding to the current position of the optical pick-up is smaller than or equal to a first boundary address value showing the start of the boundary position.

8. The method as defined in claim 6, wherein the movement of the optical pick-up to the target position via the first boundary address position comprises: comparing the current address value of the optical pick-up with the first boundary address value to determine an amount of movement of the optical pick-up, and to move the optical pick-up as much as the determined amount of movement; and comparing the first boundary address value with an address value corresponding to the target position of the optical pick-up to determine the amount of the movement of the optical pick-up and to move the optical pick-up as much as the determined amount of movement, if the optical pick-up reaches the first boundary address position.

9. The method as defined in claim 8, wherein the amount of movement of the optical pick-up for moving the optical pick-up from the current address position to the boundary address position comprises: calculating track numbers corresponding to the current address value of the optical pick-up and the first boundary address value; calculating a difference between the track number corresponding to the calculated current address value and the calculated first boundary address value to calculate a moving direction of the optical pick-up and the number of tracks; and multiplying the calculated number of tracks by a track pitch value of a track corresponding to the current address value to calculate a moving distance to be covered by the optical pick-up, and to determine an amount of movement of the optical pick-up based on the calculated moving distance.

10. The method as defined in claim 9, wherein the calculation of the number of tracks between the track number corresponding to the current address value and the track number corresponding to the first boundary address value comprises: calculating a difference between the track number corresponding to the current address value and the track number corresponding to the second boundary address value to calculate the number of tracks to be covered by the optical pick-up; and adding the calculated number of tracks to the number of tracks between pre-calculated and stored first and second boundary addresses to calculate the number of tracks between the current address value and the first boundary address value.

11. The method as defined in claim 8, wherein the amount of movement of the optical pick-up for moving the optical pick-up from the first boundary address position to the target position comprises: calculating a track number corresponding to the target address value of the optical pick-up; calculating a difference between the track number corresponding to the first boundary address value and the track number corresponding to the target address value to calculate the moving direction of the optical pick-up and the number of tracks; and multiplying the calculated number of tracks by the track pitch value of the track corresponding to the target address value to calculate the moving distance of the optical pick-up, and to determine the amount of movement of the optical pick-up based on the calculated moving distance.

12. The method as defined in claim 7, wherein the movement of the optical pick-up to the target position via the second boundary address position comprises: comparing the current address value of the optical pick-up with the second boundary address value to determine the amount of movement of the optical pick-up and to move the optical pick-up as much as the determined amount of movement; and comparing the second boundary address value with the target address value of the optical pick-up to determine the amount of movement of the optical pick-up and to move the optical pick-up as much as the determined amount of movement, if the optical pick-up reaches the second boundary address position.

13. The method as defined in claim 12, wherein the amount of movement of optical pick-up for moving the optical pick-up from the current address position to the second boundary address position comprises: calculating track numbers corresponding to the current address value and the second boundary address value; calculating a difference between the calculated track number corresponding to the current address value and the track number corresponding to the second boundary address value to calculate the moving direction of the optical pick-up and the number of tracks; and multiplying the calculated number of tracks by a track pitch value corresponding to the current address value to calculate the moving distance to be covered by the optical pick-up, and to determine the amount of movement of the optical pick-up based on the calculated moving distance.

14. The method as defined in claim 13, wherein the calculation of the number of tracks between the track number corresponding to the current address value and the track number corresponding to the second boundary address value comprises: calculating a difference between the track number corresponding to the current address value and the track number corresponding to the first boundary address value to calculate the number of tracks to be covered by the optical pick-up; and adding up the calculated number of tracks to the number of tracks between the first boundary address value and the second boundary address value to calculate a total number of tracks between the current address value and the second boundary address value.

15. The method as defined in claim 12, wherein the amount of movement of the optical pick-up for moving from the second boundary address position to the target address position comprises: calculating a track number corresponding to the target address value; calculating a difference between the track number corresponding to the second boundary address value and the track number corresponding to the target address value to calculate the moving direction of the optical pick-up and the number of tracks; and multiplying the calculated number of tracks by a track pitch value corresponding to the target address value to calculate the moving distance of the optical pick-up, and to determine the amount of movement of the optical pick-up based on the calculated moving distance.

16. A data recording/reproducing method in recording media, the method comprising: discriminating whether a target position and a current position of an optical pick-up are present in a zone where track pitches are different thereamong in response to a data recording/reproducing command; and using a boundary address value in which track pitches are changed and track pitch values of each zone to determine an amount of movement for moving the optical pick-up to a target position if the current position and the target position of the optical pick-up are respectively present in a zone where the track pitches are different thereamong as a result of the discrimination; and moving the optical pick-up as much as the determined amount of movement.

17. The method as defined in claim 16, wherein the discriminating step comprises: comparing the address values corresponding to the current position and target position of the optical pick-up with the boundary address value to discriminate whether the current position and the target position of the optical pick-up are present in a zone where the track pitches are different thereamong.

18. The method as defined in claim 16, wherein the boundary address value is an address value closest to an address value corresponding to the target position of the optical pick-up, if there are present a plurality of boundary address values between the current position of the optical pick-up and the target position.

19. The method as defined in claim 16, wherein the determination of the amount of movement when the optical pick-up is moved from a first zone to a second zone where track pitches are different comprises: calculating track numbers corresponding to an address value corresponding to the current position of the optical pick-up, an address value corresponding to the target position, a first boundary address value showing a start of the boundary address value, and a second boundary address value showing an end of the boundary address value; calculating a first number of tracks between a track number corresponding to the current address value of the optical pick-up and a track number corresponding to the first boundary address value and a second number of tracks between a track number corresponding to the second boundary address value and a track number corresponding to the target address value; multiplying the first number of tracks by a track pitch value of a track corresponding to the current address value to calculate a first moving distance to be covered by the optical pickp-up, and multiplying the second number of tracks by a track pitch value of a track corresponding to the target address value to calculate a second moving distance; adding up the calculated first moving distance to the second moving distance and a moving distance between the pre-calculated and stored first and second boundary address values to calculate a total moving distance to be covered by the optical pick-up, and determining an amount of movement of the optical pick-up based on the calculated total moving distance.

20. The method as defined in claim 16, wherein the determination of the amount of movement of the optical pick-up from the second zone to the first zone where the track pitches are different comprises: calculating track numbers corresponding to an address value corresponding to the current position of the optical pick-up, an address value corresponding to the target position, a first boundary address value showing a start of the boundary address value, and a second boundary address value showing an end of the boundary address value; calculating a first number of tracks between a track number corresponding to the current address value of the optical pick-up and a track number corresponding to the second boundary address value and a second number of tracks between a track number corresponding to the first boundary address value and a track number corresponding to the target address value; multiplying the first track number by a track pitch value of a track corresponding to the current address value to calculate a first moving distance to be covered by the optical pick-up and multiplying the second track number by a track pitch value of a track corresponding to the target address value to calculate a second moving distance; and adding the calculated first moving distance to the second moving distance and a moving distance between the pre-calculated and stored first and second boundary address values to calculate a total moving distance to be covered by the optical pick-up and to determine the amount of movement of the optical pick-up based on the calculated total moving distance.
